(19) United States
(12) Patent Application Publication
(10) Pub. No.: US 2005/0026506 A1
(43) Pub. Date: Feb. 3, 2005

(54) Modular cross-connect with hot-swappable modules

(75) Inventors: Thong Binh Kha, Simi Valley, CA (US); Jeff Clarke Murphy, Winnetka, CA (US); Wayne A. Zahlit, Thousand Oaks, CA (US); Esfir Felman, Tarzana, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Trompeter Electronics, Inc.

(21) Appl. No.: 10/871,706

(22) Filed: Jun. 21, 2004

Related U.S. Application Data
(63) Continuation-in-part of application No. 10/298,478, filed on Nov. 18, 2002, now Pat. No. 6,752,665.

(51) Int. Cl. H01R 27/02

(52) U.S. Cl. 439/638

(57) ABSTRACT

A modular cross-connect includes a chassis configured to receive a cross-connect module therein and including a front face and a rear cover. A plurality of fixed printed circuit boards (PCBs) are mounted in the chassis such that rear facing connectors of each of the fixed PCBs extend outward from the rear cover of the chassis. Each fixed PCB has a front-facing connector configured to mate with a rear-facing connector of a corresponding a cross-connect module. A plurality of slots in the front face of the chassis are configured to receive a cross-connect module and to align a rear-facing connector the cross-connect module for connection with a front-facing connector of the fixed PCB. Each front facing connector of the fixed PCBs includes at least one ground contact and a plurality of signal contacts, such that upon insertion of the cross-connect module into the chassis, the ground contacts engage the rear-facing connector before the signal contacts engage the rear facing connector.

### CROSS REFERENCE TO RELATED APPLICATIONS

This application is a continuation-in-part of commonly assigned U.S. patent application Ser. No. 10/298,478, filed on Nov. 18, 2002, entitled MODULAR CROSS-CONNECT WITH REMOVABLE SWITCH ASSEMBLY, which is incorporated herein by reference in its entirety.

### BACKGROUND OF THE INVENTION

1. Field of the Invention

The present invention relates to a modular cross-connect used for routing, monitoring and testing of signals in, for example, the telecommunications industry.

2. Related Art

Digital signal cross-connect (DSX) equipment plays an important part in the installation, monitoring, testing, restoring, and repairing of digital communications networks. Digital signal cross-connect modules are often used to provide cross-connections of digital signal lines at locations that are suited for testing and repairing the digital lines. For instance, many telephone service providers' central offices have digital signal cross-connect modules. A single DSX module generally interconnects two telecommunications apparatuses of a telecommunications network. The module is typically mounted in a rack or bank with similar modules. The bank forms a digital signal cross-connect unit (DSX unit). The DSX modules provide a point of access to the digital signals being transmitted over the digital lines of the telecommunications network, yet appear as almost invisible to the rest of the network. By utilizing the DSX modules, an operator can monitor, test and repair the digital equipment that is used by the telecommunications network without significantly interfering with the transmission of signals.

A need exists in the industry for low cost DSX chassis that have high density of modules. Additionally, a need exists for being able to swap the modules in and out during operation (“hot swapping”), without a loss of data integrity, or without introcuding bit errors during the module hot swap.

### BRIEF SUMMARY OF THE INVENTION

Accordingly, the present invention is directed to a modular cross connect with hot-swappable modules that substantially obviates one or more of the problems and disadvantages of the related art.

There is provided a modular cross-connect including a chassis configured to receive a plurality of cross-connect modules therein and having a front face and a rear cover. A plurality of fixed rear PCB assemblies are mounted in the chassis such that rear facing connectors of each of the fixed rear PCB assemblies extend outward from the rear cover of the chassis. Each fixed rear PCB assembly has a front-facing connector configured to mate with a rear-facing connector of a corresponding removable module.

A plurality of slots are formed in the chassis. Each slot is configured to receive a cross-connect module and to align a rear-facing connector of a cross-connect module for connection with a front-facing connector of a fixed rear PCB assembly. A plurality of doors are at the front face of the chassis, each door corresponding to one of the plurality of slots and being pivotally mounted for rotation about an axis parallel to a width of the chassis. Insertion of a cross-connect module into one of the plurality of slots causes a corresponding one of the plurality of doors to pivot about the axis to permit entry of the cross-connect module into the chassis.

In a further aspect of the invention, each door includes a rail for guiding the module during insertion. Doors are mounted on a horizontally mounted rod extending in a direction perpendicular to the direction of insertion.

In a further aspect of the invention, each module includes a release lever and a locking tab for coupling to a corresponding door. In a further aspect of the invention a rail plate with grooves is added for guiding the modules during insertion. In a further aspect of the invention, each module includes two release levers and two locking tabs for coupling to a corresponding door and to a rail plate mounted over the bottom plate.

In a further aspect of the invention each module includes a printed circuit board. In a further aspect of the invention, the modules may be inserted in two different orientations. In a further aspect of the invention, there is included a connector on the printed circuit board for engaging the module when the module is inserted, the connector having a chamfered edge. The connector may be a multi-pin make-before-break connector.

In a further aspect of the invention, the top housing assembly of the chassis includes a Printed Circuit Board assembly with a plurality of switches, each of the switches having an LED integrally mounted within it. In a further aspect of the invention, each module includes a micro-strip line PCB. The Printed Circuit Board assembly also includes a micro-strip line PCB.

In a further aspect of the invention each switch includes a removable lense over the LED. In a further aspect of the invention the module includes a plurality of jacks on its front side, each jack including a strain relief.

In a further aspect of the invention, the modular cross-connect includes a chassis configured to receive a plurality of cross-connect modules therein and including a front face and a rear cover. A plurality of fixed printed circuit boards (PCBs) are mounted in the chassis such that rear facing connectors of each of the fixed PCBs extend outward from the rear cover of the chassis. Each fixed PCB has a front-facing connector configured to mate with a rear-facing connector of a corresponding cross-connect module. A plurality of slots in the front face of the chassis are configured to receive a cross-connect module and to align a rear-facing connector of the cross-connect module for connection with a front-facing connector of the fixed PCB. Each front facing connector of the fixed PCBs includes a plurality of ground (and optionally power) contacts and a plurality of signal contacts, such that upon insertion of the cross-connect module into the chassis, the ground contacts electrically engage corresponding contacts on the rear-facing connector before the signal contacts are electrically engaged.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 is a front isometric view of one embodiment of a cross-connect chassis of the present invention.

FIG. 2 is a rear isometric view of one embodiment of the chassis of the present invention.

FIG. 3 is an isometric assembly view of an cross-connect module of one embodiment of the present invention.

FIG. 4 is a partial cross-sectional view of a chassis and one inserted cross-connect module of one embodiment of the present invention.

FIGS. 5A-5E show different views of a cross-connect module of one embodiment of the present invention.

FIG. 5F shows a partial plan view of a printed circuit board (PCB) of a fixed rear PCB assembly mated to a printed circuit board of the cross-connect module.

FIGS. 6A-6C illustrate three different views of a fixed PCB assembly portion of one embodiment of the present invention.

FIGS. 7A-7C illustrate the printed circuit board of an insertion module of one embodiment of the present invention.

FIG. 8 illustrates a top housing assembly of the chassis of one embodiment of the present invention.

FIG. 9 illustrates a cross-sectional view of the top housing assembly.

FIG. 10 illustrates an isometric view of a PCB assembly portion of the top housing assembly.

FIG. 11 shows an isometric view of a rail plate of one embodiment of the present invention.

FIG. 12 illustrates additional detail of a door of one embodiment of the present invention.

FIG. 13 illustrates how multiple doors are assembled in the chassis.

FIG. 14 illustrates a cross-section of a make-before-break connector.

FIG. 15 shows an electrical schematic of tracer circuitry of the chassis.

FIGS. 16-17 illustrate electrical schematics of connections between the cross-connect modules and chassis in two different insertion orientations.

FIGS. 18-22 illustrate an alternative edge connector for the rear PCB assembly that improves the hot swapping capability of the cross-connect modules.

FIGS. 23-24 illustrate another alternative edge connector for the rear PCB assembly that improves the hot swapping capability of the cross-connect modules.

### DETAILED DESCRIPTION OF THE INVENTION

Reference will now be made in detail to the preferred embodiments of the present invention, examples of which are illustrated in the accompanying drawings.

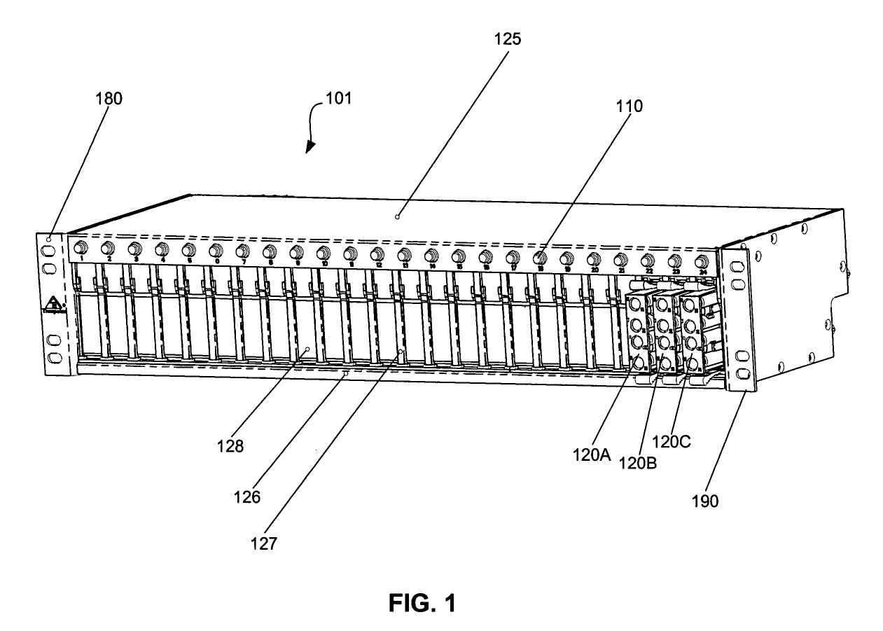

One embodiment of a cross-connect of the present invention is described with reference to FIGS. 1-22.

FIG. 1 is a front isometric view of a chassis 101 that receives a plurality of modules 120. Three cross-connect modules 120A-120C are depicted for purposes of illustration. Each module 120 is inserted into an interior space of chassis 101. Sides of chassis 101 include a left side panel 180 and a right side panel 190. Chassis 101 also includes a top housing assembly 125, left and right side panels 180, 190, a bottom plate 126, a plurality of spacers 127, and a plurality of doors 128, which are shown in a closed position in FIG. 1. Doors 128 are closed when modules 120 are removed to minimize the amount of dust and other debris that may enter the interior of chassis 101. FIG. 1 also shows push buttons 110, with internal LEDs.

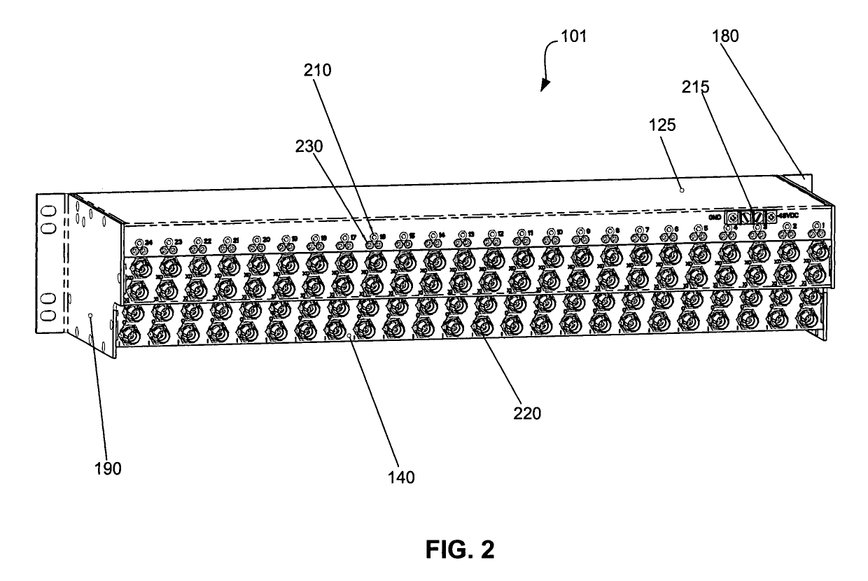

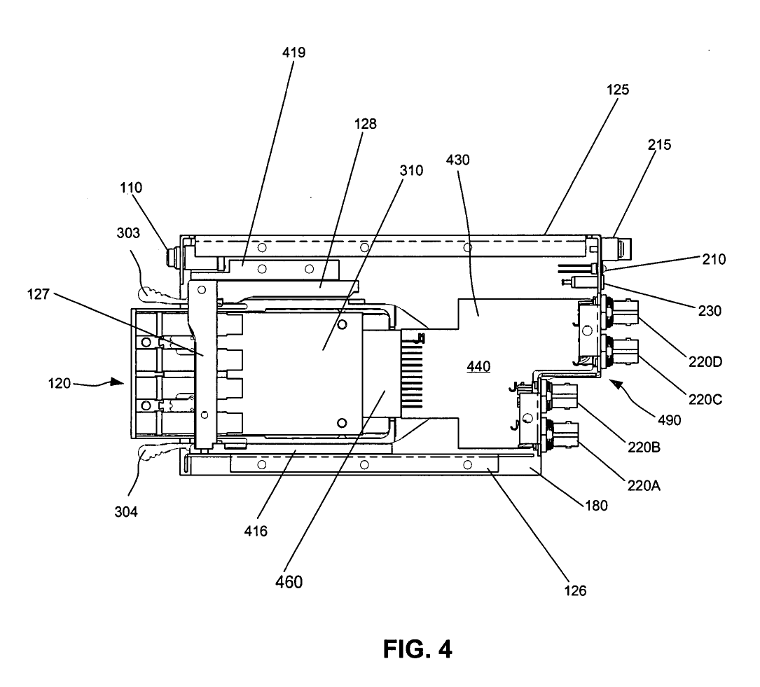

FIG. 2 is a rear isometric view of chassis 101. A back wall (rear cover) 140 of chassis 101 has a plurality of circular openings. When module 120 is positioned in chassis 101, BNC jacks 220 extending from a rear portion of module 120 extend outward from corresponding openings in back wall 140. Each BNC jack 220 is preferably secured in position in an opening of back wall 140 by a nut 490 (not shown in FIG. 2, see FIG. 4) that mates with a threaded portion on the body of jack BNC 220. This also secures the rear portion (discussed below) of module 120 in chassis 101.

As further shown in FIG. 2, chassis 101 includes left side panel 180 and right side panel 190. Top housing assembly 125 includes a terminal block 215, LEDs 210, and tracer ports 230.

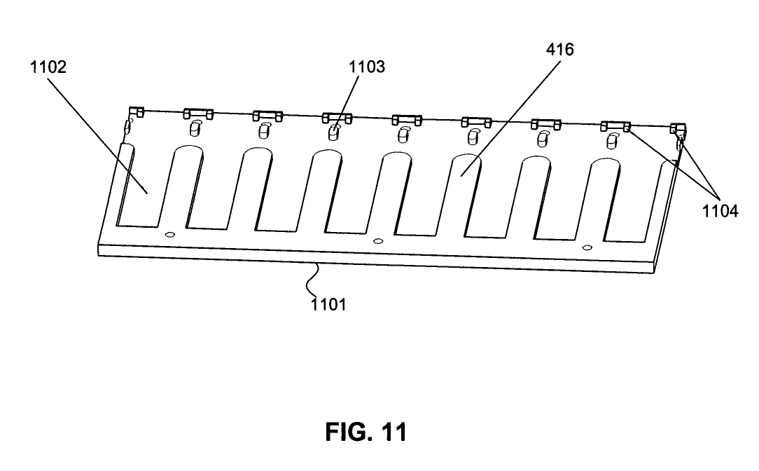

Chassis 101, as shown in FIGS. 1 and 2, includes top housing assembly 125, side panels 180, 190, bottom plate 126, and rear cover 140. Rear cover 140 is also used as a dust cover and a platform to securely mount the rear portion of modules 120. Top housing assembly 125 is used for mounting switches 110, tracer lights 210, tracer port 230, and power wiring. Bottom plate 126 is used as a platform to mount and support rail plate 1101 (see FIG. 11).

FIG. 4 is a side or end cross-sectional view of chassis 101 illustrating positioning of module 120 within chassis 101. This view illustrates that chassis 101 includes a fixed rear PCB assembly 440 into which removable modules 120 (also called switch PCB assemblies) may be inserted. Module 120 is electrically connected to fixed rear PCB assembly 440 by an edge connector 460 (a multi-pin connector). Edge connector 460 of fixed rear PCB assembly 440 mates with an edge of a printed circuit board (PCB) 310 of module 120. The rear portion of the PCB 310 may be thought of as a rear-facing connector. Rear facing connector (edge connector 460) preferably has chamfer edges and nickel/gold plating to improve reliability by reducing wear during insertion to and withdrawal from rear PCB assembly 440.

Printed circuit board 310 of module 120 mates with rear PCB assembly 440. Side panel 180 is shown at the bottom of the assembly in FIG. 4. An upper support bar 419 is shown at the top of the assembly. A rail 416 of rail plate 1101 at bottom is used to guide insertion of module 120. FIG. 4 also shows a cross-section of top housing assembly 125, terminal block 215, and a cross-section of bottom support plate 126. As illustrated, top housing assembly 125 includes push button switch 110 tracer port 230, and rear LED 210.

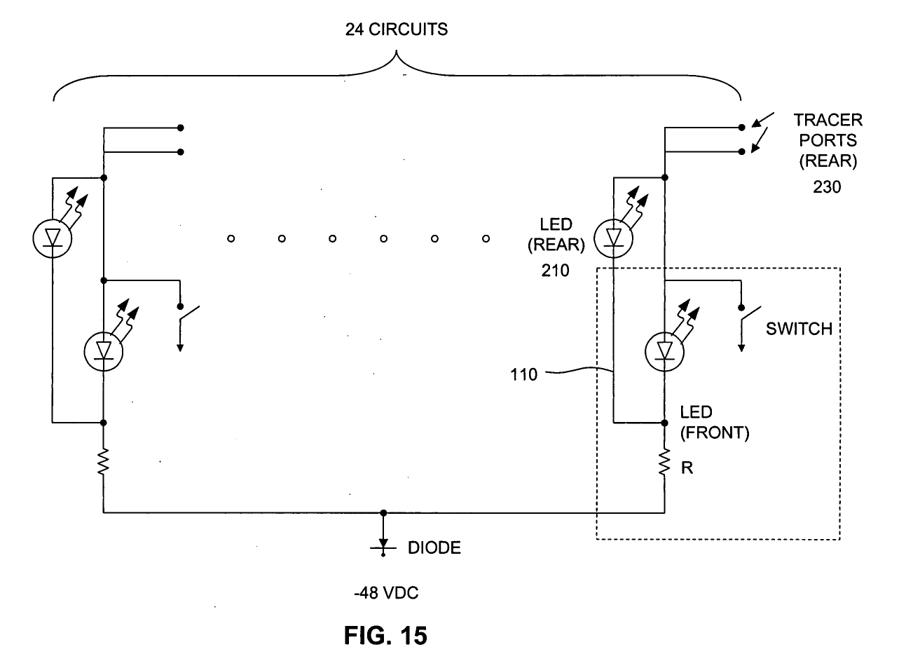

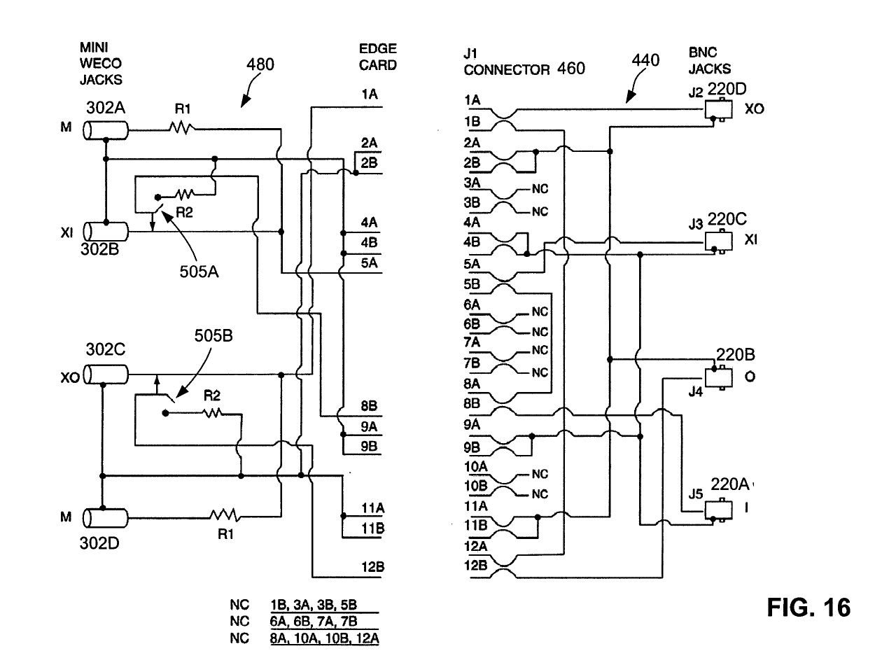

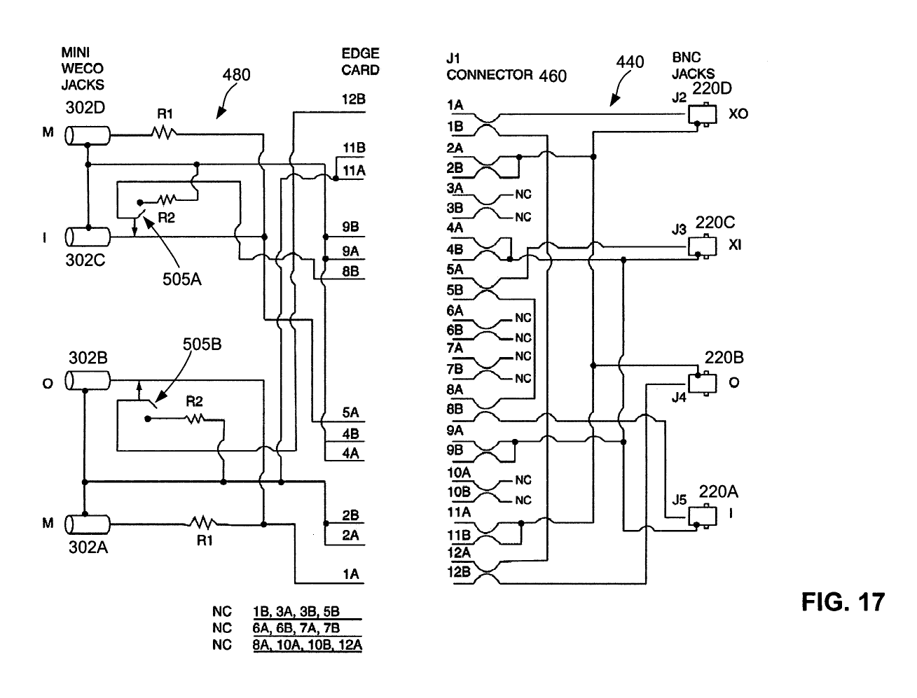

Rear PCB assembly 440 includes 4 edge-mount BNC jacks 220, a PCB board 430, and a make-before-break edge connector 460. Microstrip line techniques are used on the board design to control the impedance of the conductors to achieve optimum RF parameters. An input signal normally enters at BNC “IN” jack 220A, moves through a micro-strip line on one side of board 430, loops through multi-pin connector 460, moves through a micro-strip line on the other side of PCB 430, and exits at BNC “XIN” jack 220C. The signal paths are similar for “OUT” and “XOUT.” Specifically, an output signal normally enters through BNC “XOUT” jack 220D, moves through a micro-strip line on one side of board 430, loops through multi-pin connector 460, moves through a micro-strip line on the other side of board 430, and exits at BNC “OUT” jack 220B. (See also circuit diagram of FIG. 15, which shows an electrical schematic of tracer circuitry of chassis 101, and FIGS. 16-17, which show electrical schematics of module 120 and chassis 101 in two different insertion orientations.)

When module 120 is inserted and mates with rear PCB assembly 440, contacts of multi-pin edge connector 460 are forced open by an edge of PCB 310 and the signals are routed through PCB 310 and then back to the rear PCB 430 before leaving chassis 101. Thus, module 120 allows the user to monitor the signals and re-route them if necessary.

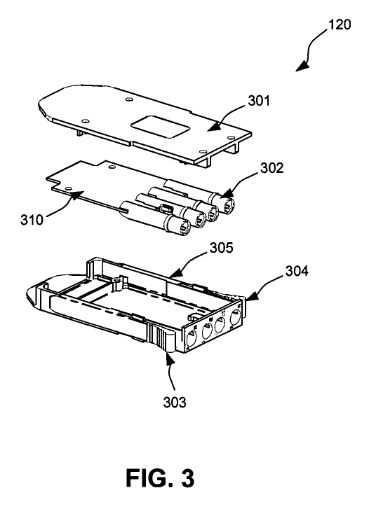

FIG. 3 shows an exploded, isometric view of module 120. As shown in FIG. 3, module 120 includes a thermoplastic housing (frame) 305, a thermoplastic lid 301, and a printed circuit board (PCB) 310 that includes four mini-WECo jacks 302. PCB 310 is enclosed within thermoplastic housing 305 and thermoplastic lid 301. FIG. 3 also shows two locking release levers 303, 304, which are used to disengage module 120 from chassis 101 for withdrawal.

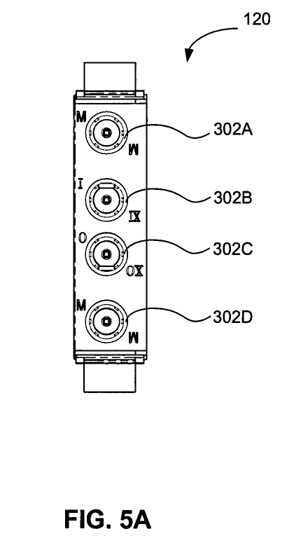

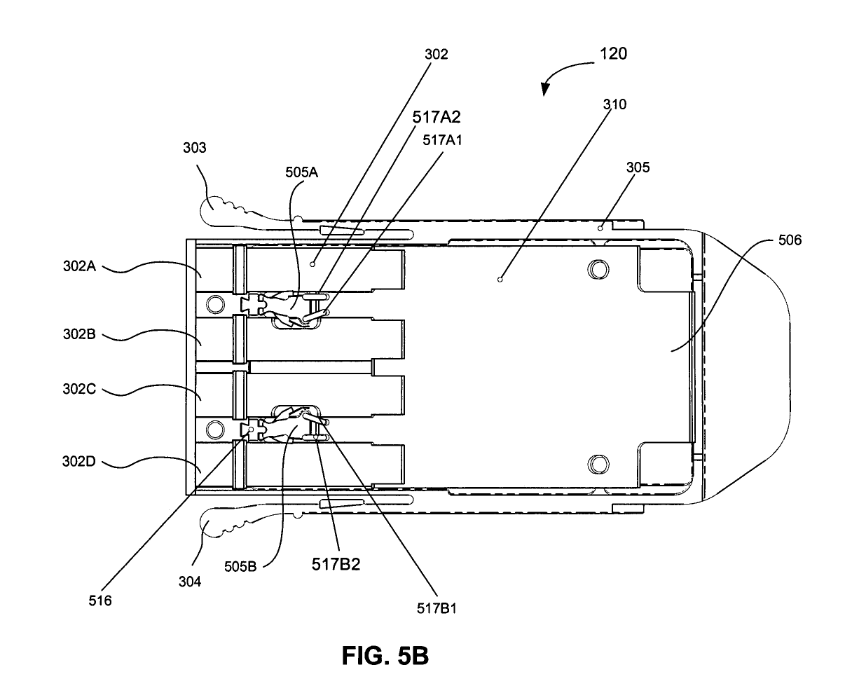

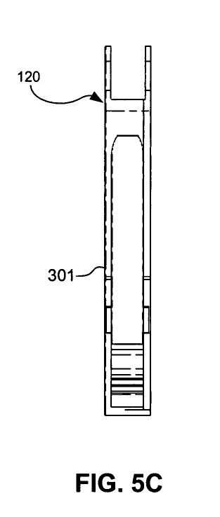

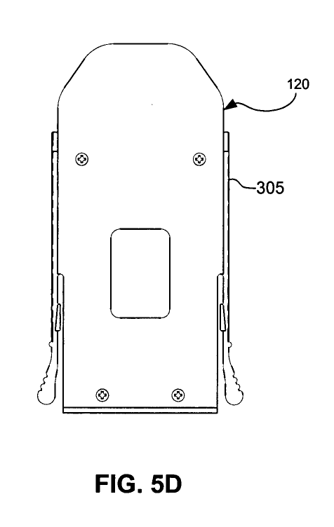

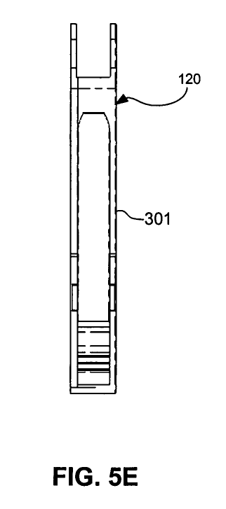

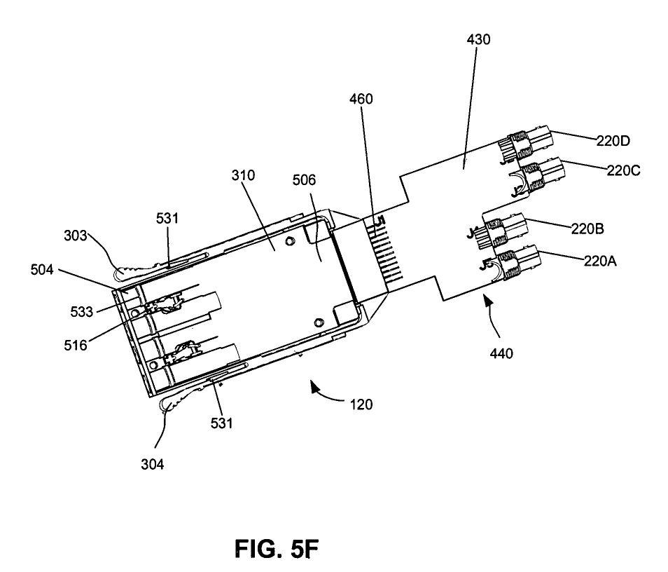

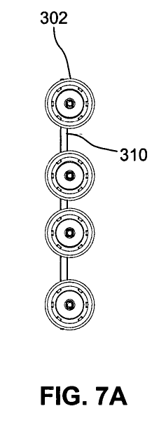

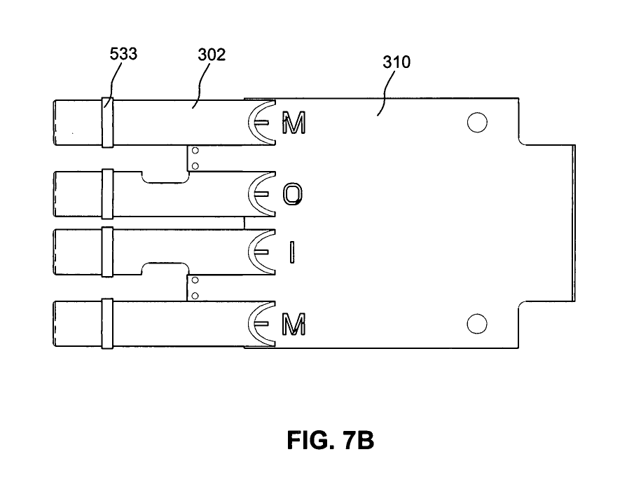

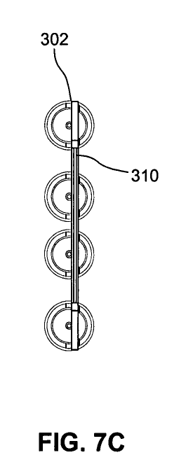

FIGS. 5A-5B show two views of removable module 120. Module 120 includes housing (frame) 305 having PCB 310 mounted therein. (Several views of PCB 310 are also shown in FIGS. 7A-7C.) PCB 310 includes a portion 506 configured for mating with edge connector 460 of fixed rear PCB assembly 440. Four MiniWECo jacks 302 are mounted on a front edge of PCB 310. Micro-strip conductors on PCB 310 carry electrical signals from portion 506 to jacks 302. A first switch assembly 505A normally connects the conductors of jacks 302B and contact post 517A2. A second switch assembly 505B normally connects the conductors of jacks 302C and contact post 517B2. Switch 505A is connected to contact post 517A1 (breaking the normal connection) upon insertion of a MiniWECo plug into jack 302B. Similarly, switch 505B is connected to 517B1 (breaking the normal connection) upon insertion of a MiniWECo plug into jack 302C. 302A and 302D are for monitoring purposes. FIG. 5B also shows a view of actuator 516 and contact post 517, which are positioned towards the front of module 120.

FIGS. 5C-5E show additional views of module 120. Specifically, FIGS. 5C and 5E show side views of module 120, and FIG. 5D shows module 120 with thermoplastic lid 301 mounted and closed.

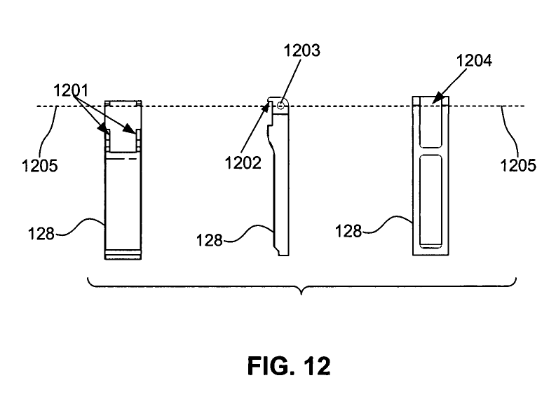

FIG. 5F shows another partial view of module 120 that is mated with rear PCB assembly 440. Rear PCB assembly 440 includes micro-strip line PCB 430, BNC jacks 220 coupled to PCB 430, and edge connector 460. Module 120, which is mated with rear PCB assembly 440, includes, as also shown in previous figures, PCB 310, mini-WECo jacks 302, and actuator 516. Module 120 also includes a rail ridge (see also FIG. 12, element 1201) at the top, locking release levers 303, 304 and locking tabs 531. Each mini-WECo jack 302 also has a strain relief ridge 533, for improved product reliability. Strain relief ridges 533 are designed to minimize the insertion forces imposed on solder joints between the mini-WECo jack 302 and PCB 310. It will absorb and distribute the forces onto chassis 101 and thus can prevent solder joint fracture that will eventually degrade performance of chassis 101.

Referring to FIGS. 4, 5A and 5C, fixed rear PCB assembly 440 is described in further detail. Fixed rear PCB assembly 440 includes PCB 430 upon which BNC jacks 220 are mounted at one edge. Edge connector 460 is mounted on an opposite edge of PCB 430. Microstrip conductors on PCB 430 electrically connect BNC jacks 220 to edge connector 460. Edge connector 460 makes connections between the conductors so that jack 220A is normally connected to jack 220C, and jack 220B is normally connected to jack 220D, to provide cross-connect functionality. However, when module 120 is mated with edge connector 460, the normal connections made by edge connector 460 are broken and the conductors are instead electrically connected to conductors within module 120.

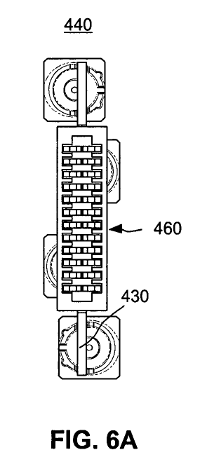

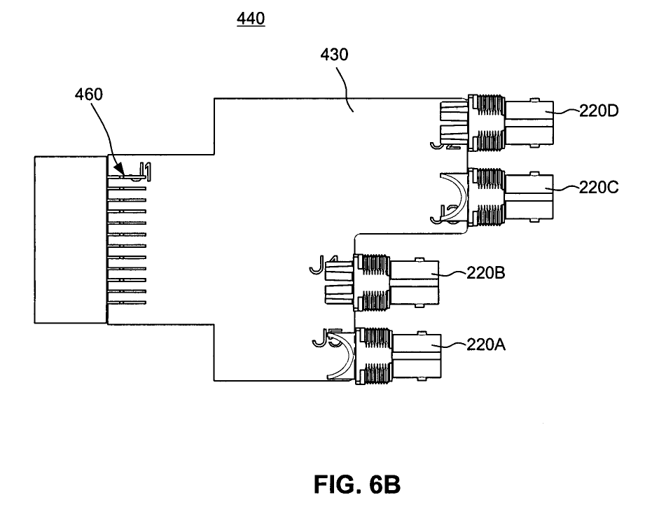

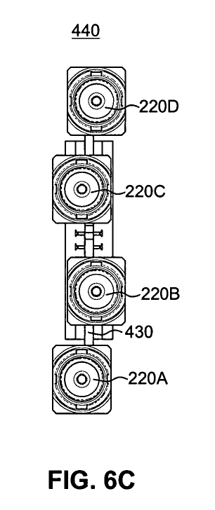

FIGS. 6A-6C illustrate additional views of fixed rear PCB assembly 440 of module 120. Specifically, FIG. 6A illustrates a front view of fixed rear PCB assembly 440 (i.e., looking into chassis 101 through open door 128), FIG. 6B illustrates a side view of fixed rear PCB assembly 440, and FIG. 6C illustrates a back view of fixed rear PCB assembly 440, looking from the rear of chassis 101 towards BNC jacks 220.

FIGS. 7A-7C illustrate three additional views of printed circuit board 310 of module 120. Specifically, FIG. 7A shows a view looking into chassis 101 from the front, illustrating mini-WECo jacks 302 and a cross-section of PCB 310. FIG. 7B illustrates a side view (i.e., looking at PCB 310 from a direction of right side panel 190), and FIG. 7C shows a rear view of PCB 310. Note in particular mini-WECo jacks 302 and their stress relief ridges 533 in FIG. 7B.

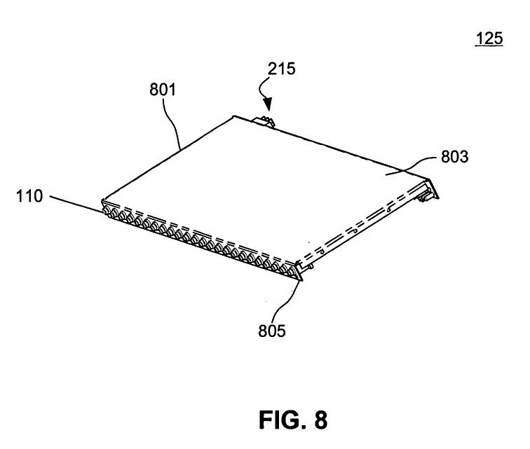

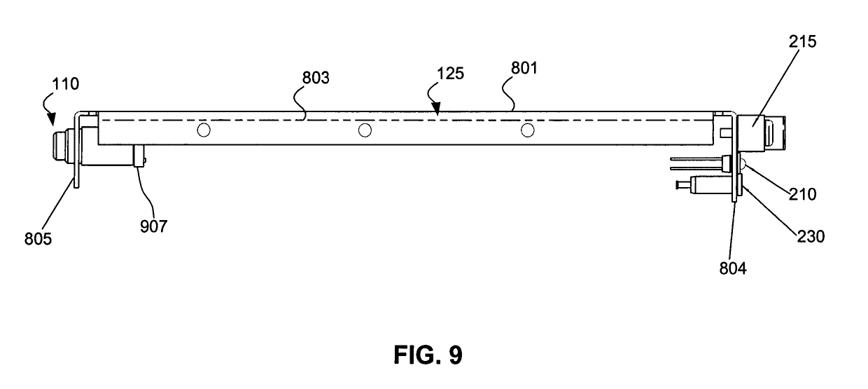

FIGS. 8 and 9 illustrate top housing assembly 125 that forms the top portion of chassis 101. Top housing assembly 125 includes a chassis member 801 having a portion 803 that forms a top face of chassis 101, a portion 805 that forms part of the front face of chassis 101 and a portion 804 that forms part of the rear face of chassis 101. Switches 110 are structurally mounted on a PCB assembly portion 805. LEDs 210 and tracer ports 230 are mounted on portion 804. Switches 110 are electrically connected to a PCB 907. LEDs 210 and tracer ports 230 are electrically connected to PCB assembly 907 via wires (not shown). PCB assembly 907, terminal block 215, LEDs 210, tracer ports 230 and switches 110 constitute tracing circuitry that typically has no electrical interconnection to modules 120. Configuration and operation of tracer circuitry would be apparent to a person skilled in the relevant art, and is illustrated in schematic form in FIG. 15.

The PCB assembly 907 includes a PCB with pre-installed surface mount resistors and diodes (not shown in the figures), and push-button switch assemblies that include switch bodies 110, with removable/replaceable color lenses, and LEDs (not shown, housed inside switch 110).

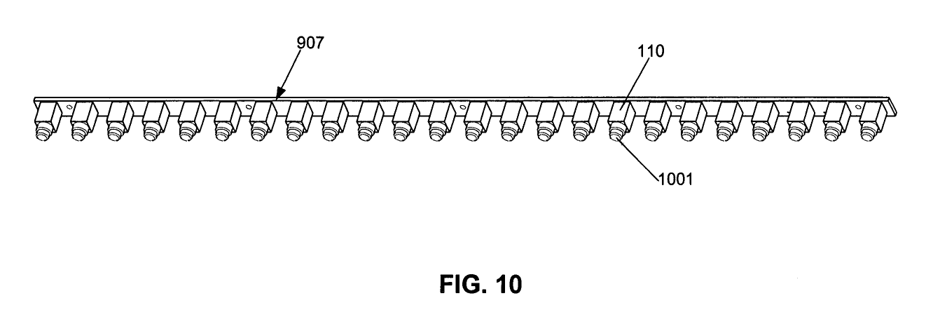

FIG. 10 illustrates an additional view of PCB assembly 907. As shown in FIG. 10, PCB assembly 907 includes a plurality of switches 110, each of which includes an LED mounted integrally within it. Each switch 110 also includes a color-coded lens 1001, which may be easily replaced in the field.

FIG. 11 is an illustration of a thermoplastic rail plate 1101, which is mounted above bottom plate 126 in chassis 101, and is used to guide modules 120 being inserted into chassis 101. As shown in FIG. 11, rail plate 1101 includes rail grooves 1102, rails 416, spacer stabilizers 1103 to keep spacers 127 from moving after installation, and locking stoppers 1104 that mate with tabs 531 for guiding and fixing in place modules 120.

FIG. 12 illustrates three views of door 128, which upon insertion of module 120, also functions as a rail guide. As shown in FIG. 12, door 128 includes upper rail ridges 1201, a lock stopper 1202, a hole 1203, and a cavity 1204 for mating with corresponding parts of module 120. Dashed line 1205 shows an axis of rotation of door 128 upon insertion of module 120.

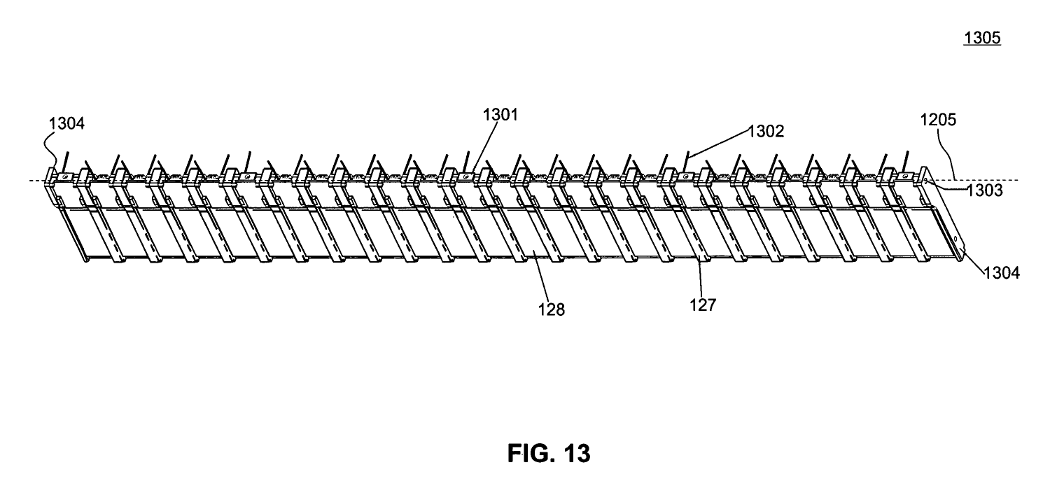

FIG. 13 illustrates additional detail of a door assembly 1305, which is mounted on the front of chassis 101. As shown in FIG. 13, door assembly 1305 includes a plurality of doors 128, separated by spacers 127. On either side of door assembly 1305, there are end spacers 1304. For each door 128, a spring 1302 acts to keep it biased towards a closed state, to prevent entry of dust and other debris. A bracket 1301 is used to couple springs 1302 to door assembly 1305. A circular rod 1303 is used to mount the springs 1302 and to link all doors 128 and spacers 127 together. End spacers 1304 and spacers 127 may be formed, for example, from metal or thermoplastic.

Door 128 is normally in a closed position until module 120 is inserted to open it. Then, door 128 serves as an upper rail, in addition to rail plate 1101, to guide module 120 to mating correctly with the multi-pin connector 460 of rear PCB assembly 440. Upon withdrawal of module 120, spring 1302 will force door 128 back to a closed position. Thus, door 128 prevents dust and other debris from entering the interior of chassis 101 and causing contamination to internal components. As compared to a side-mounted door assembly, the vertical door design allows higher module density with the same chassis size, e.g., either 19″ or 23″ wide chassis.

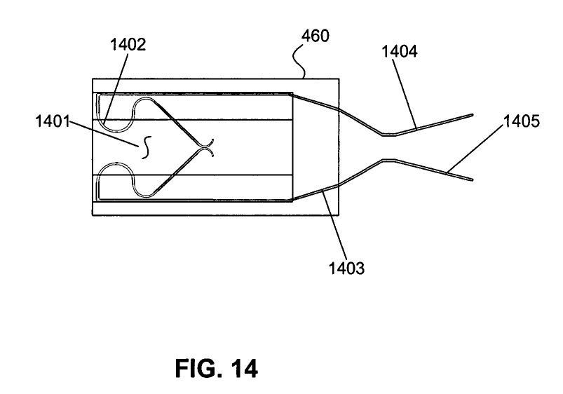

FIG. 14 shows a cross-section of connector 460. The connector shown in FIG. 14 is a make-before-break type connector. Connector 460 may also be a pin-and-socket type, which may be more reliable, and provide better performance, but would result in higher cost.

In operation, when module 120 is coupled to fixed rear PCB assembly 440 via edge connector 460, the electrical connections creating the cross-connect that were previously made by edge connector 460 (e.g., upper contacts 1402, lower contacts 1403) are instead made by switches 505A and 505B. That is, when edge 506 of PCB 310 is inserted into cavity 1401 of connector 460, contacts 1402, 1403 are forced apart, breaking the electrical connection between upper conductors 1404 and lower conductors 1405. This permits the signals from BNC jacks 220 and the connections made therebetween to be accessible at the front of module 120. (See also circuit diagrams at FIGS. 16-17.)

Referring back to FIGS. 1 and 2, chassis 101 populated with modules 120 can be used in a telephone company central office to connect telephone company equipment. In this environment, the equipment is connected to BNC jacks 220 at the rear of chassis 101. The fixed rear PCB assemblies 440 then provide the desired interconnections between the equipment. To reduce cost, modules 120 will not be needed until signal access is desired for re-routing or monitoring. Accordingly, it is anticipated that chassis 101 will typically be configured with all of fixed rear PCB assemblies 440 in position in chassis 101 prior to chassis 101 being shipped to a customer. Modules 120 can then be added or removed by a customer, as necessary.

Referring back to FIG. 1, note that chassis 101 includes a row of lighted, push-button switches 110 along the top edge of the front panel. One switch 110 corresponds to each module slot of chassis 101. Referring to FIG. 2, note that at the rear of chassis 101, there is row of tracer ports 230 and a row of tracer LEDs 210. A pair of tracer ports 230 and an LED 210 are also associated with each module slot of chassis 101.

Switches 110, ports 230 and LEDs 210 are used for troubleshooting cable runs by tracing cabling between equipment bays as is known in the art. For example, given a coaxial cable that connects a first module in a first chassis to a module in a second, remotely-located chassis, a tracer port 230 corresponding to the first module would typically be connected by a wire to a tracer port on the second, remotely-located module. Depressing switch 110 associated with the first module would then complete an electrical circuit that would (1) light an LED within switch 110 itself, (2) light rear panel LED 210 associated with the first module, and (3) light the remotely-located, rear panel LED associated with the second module. This facilitates the tracing of cabling by technicians for troubleshooting.

DSX chassis 101 of the present invention with cross-connect modules 120 installed provides signal crossing functions in digital networks located in a central cross connecting location for the ease of testing, monitoring, restoring and repairing the digital signals and associated equipment. Chassis 101 with BNC jacks 220 of fixed rear PCB assemblies 440 preinstalled into chassis 101 can provide only crossing function capability. However, chassis 101 with removable module 120 installed can provide capabilities for testing, monitoring, and rerouting the digital signals as well as providing the normal crossing functionality.

Note that, when installed in a first orientation, module 120 permits front-panel access to the following signals: IN, OUT, MONITOR IN and MONITOR OUT. However, if module 120 is installed in a different orientation (i.e., rotated 180 degrees so that the MiniWECo jack 302 that was on the top is on the bottom after rotation), module 120 permits front-panel access to the following signals: XIN, XOUT, MONITOR XIN and MONITOR XOUT. (See also electrical schematics of FIGS. 16-17.) This feature permits front panel access to all back-panel signals. Furthermore, signal access is achieved in a module size that is smaller that would be required to provide simultaneous access to back-panel signals, permitting a size savings in module 120 and chassis 101.

The DSX chassis 101 is designed to provide cross connect and interconnect functions for equipment carrying, for example, DS3 broadband signals. The DSX chassis 101 is also designed to pass the crossed signals without the need for modules 120. However, the modules 120 are needed when those crossed signals need to be monitored, patched or rearranged. Furthermore, it is desirable to be able to “hot swap” a module. That is, it is desirable to be able to plug a module into a slot while the corresponding rear PCB is cross-connecting “live” signals.

The inventors have discovered a problem with hot swapping modules. Specifically, it is believed that a static charge builds up on the module. When the statically-charged module is plugged into the connector of the fixed PCB in the chassis, the static charge causes bit errors in the signals flowing through the connector pins. A similar problem may occur when removing a module.

The inventors have further discovered a solution for the bit-error problem. Specifically, the problem can be eliminated by removing the charge on the module before signal pins of connector 460 are engaged. One way to accomplish this is to have the module 120 ground make contact with rear PCB assembly 440 ground prior to engaging the signal pins of the connector. Similarly, upon removal of module 120, the ground contacts are configured to disengage last.

Under normal operating condition, a signal enters through a rear jack's I or O jack of the modular cross connect chassis 101, loops through the make-before-break connector 460 and exits through rear XI or XO jack, respectively (see FIGS. 5A and 6B). In one embodiment, connector 460 has, e.g., twelve pairs of contacts 1404, 1405 (see FIG. 14) mounted in a straight row as illustrated in FIG. 2. When the module 120 is inserted into the chassis 101 and mated with the connector 460, all contact pairs of the connector 460 mate approximately simultaneously (subject, for example, to manufacturing tolerances and bent pins) with PCB 310 contacts. As the module 120 moves in further, it breaks the contact pairs 1402, 1403 open and the signals move to the module 120, allowing the user to patch, monitor or rearrange the signals.

With a conventional connector as depicted in FIG. 14, static charge built-up on the module can enter the contacts of connector 460 and cause bit errors as discussed above. Testing shows that the bit errors occur randomly. For example, in one test run by the inventors that involved cross-connection of simulated DS3 signals, a total of 48 bit errors occurred during 100 module insertions.

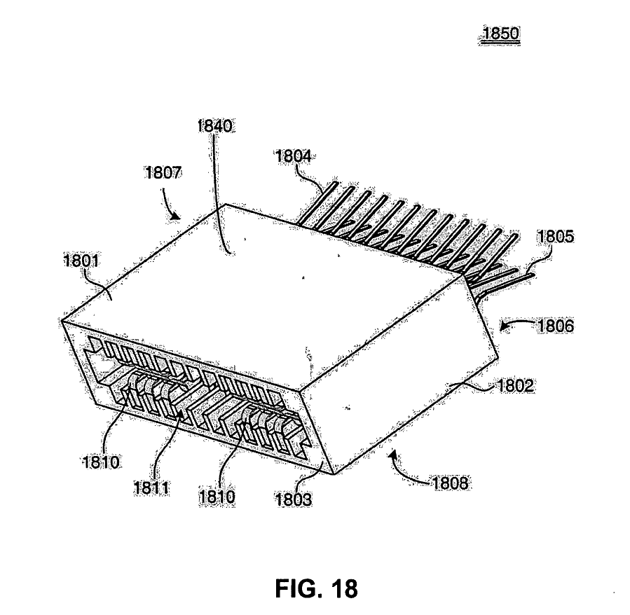

This problem can be reduced or eliminated by redesigning the connector 460. Thus, in one embodiment, ground contacts of the connector are offset (e.g., 0.20 inches) from signal contacts as illustrated in FIGS. 18-22. With the offset, the module's ground contacts will make contact with the ground contacts of the connector prior to the engagement of the signal contacts. This will allow discharge of the static charge on the module before the signal contacts are connected between the module and the connector.

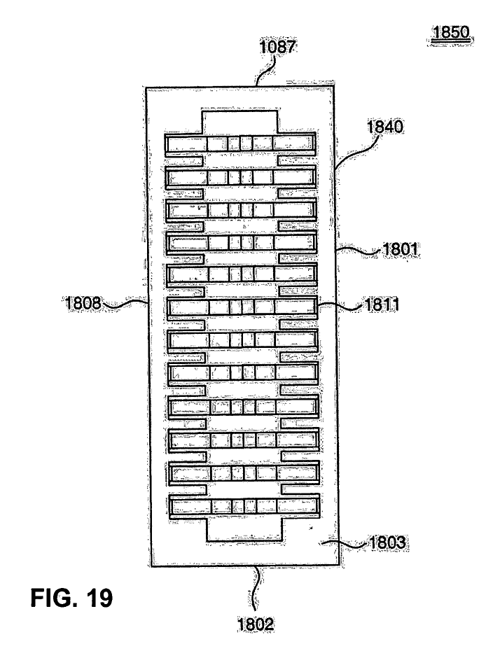

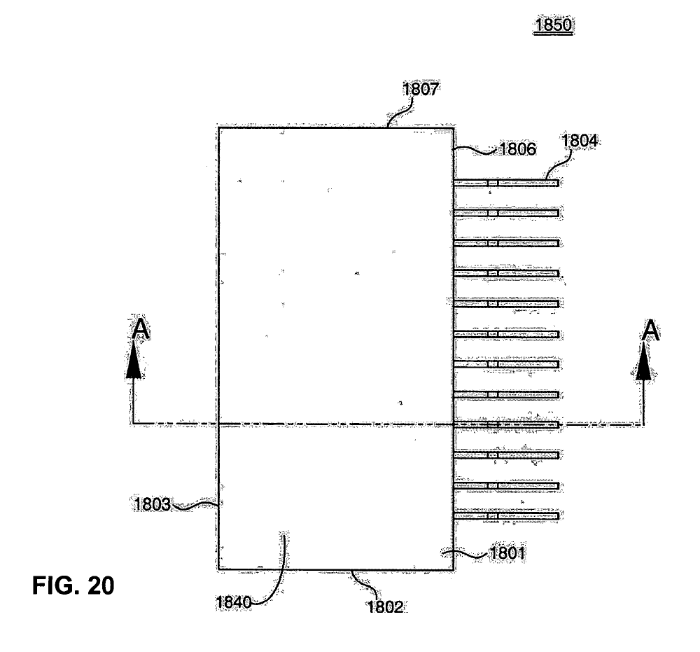

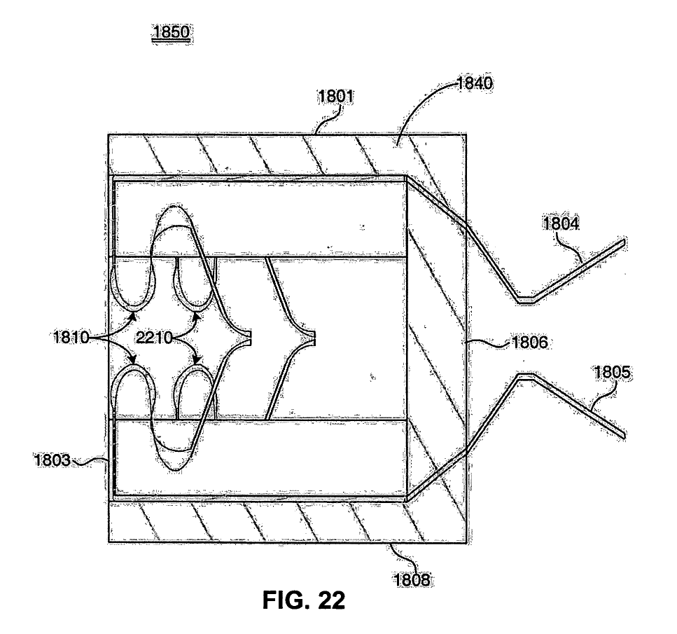

FIGS. 18-22 show the alternative form of an edge connector 1850 for the rear PCB assembly 440 that permits the hop-swapping of modules 120 with reduced bit errors. FIG. 18 shows an isometric three-dimensional view of the alternative connector 1850, FIGS. 19, 20 and 21 show side views of the connector 1850, and FIG. 22 shows a cross-section of the connector 1850 across line A-A of FIG. 20.

As shown in FIGS. 18-22, the connector 1850 includes a housing 1840 comprising a top side 1801, a front face 1803, a rear face 1806, an upper face 1807, a bottom face 1808, and side faces 1802, 1807. The connector 1850 also includes a set of upper contacts 1804, and lower contacts 1805 (in one embodiment, twelve upper contacts 1804 and twelve lower contacts 1805). The contacts 1804, 1805 are mounted within the housing 1840, such that they may be accessed from the front face 1803 through slots 1811 when the PCB 310 is inserted.

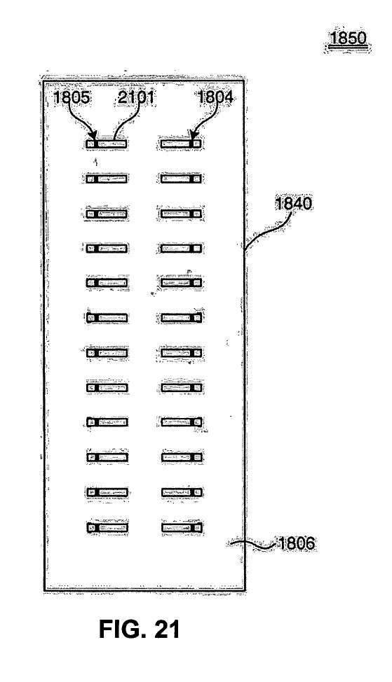

FIG. 21 shows a view of the rear face 1806, including slots 2101 through which contacts 1804 and 1805 protrude rearwardly.

As may be further seen in FIG. 18 and FIG. 22, the contacts 1804 and 1805 have curved portions 1810 and 2210. The ground contacts have curved portions 1810 that are offset forward of the curved portions 2210 of the signal contacts. Thus, as the PCB 310 of the module 120 begins engaging the connector 1850, the first contacts to mate with the PCB 310 are the ground contacts, which are also visible in FIG. 18. Once the ground connections are made, further insertion of the module 120 engages the signal contacts. In this manner, the forwardly extending ground pins can discharge any static accumulated on the modules 120 before the signal paths are affected.

In this example embodiment, the offset contacts connector 1850 has ground contacts that are, for example, 0.20 inches longer than the signal contacts. This allows the ground of the module 120, when inserted, to engage the rear PCB assembly 440 ground before engagement of the signal contacts and to thereby prevent corruption of passing signals by any different voltage potential of the front PCB 310 and the rear PCB 430.

During testing, the number of bit errors that occurred during test insertions of the PCB assembly using the offset contact connector 1850 decreased, showing that the random bit errors created during insertion of the module 120 can be reduced or possibly eliminated by using make-before-break connector 1850 with, for example, 0.20 inch offset rows of contacts. The offset allows static charge to discharge through the ground contacts prior to signal engagement.

Note that in this particular embodiment, only ground contacts are necessary, since the module 120 has no active components. Six ground contacts are shown in the example of FIG. 18. If necessary to provide power, some of the ground contacts may be used as power contacts instead. Alternatively, any number of ground and/or power contacts can be used, as needed.

In addition (or instead of) to the approach described with reference to FIGS. 18-22, other approaches to addressing the hot swap problem can be used in conjunction with or as an alternative to the solution discussed above. For example, the housing of module 120 can be made from a conductive material that is connected to ground. For example, housing 305 and lid 301 of module 120 can be made from a conductive metal (e.g., aluminum, zinc or an alloy) or conductive polymer material by machining, casting or molding. Alternatively, housing 305 and lid 301 can be plated or wrapped in a conductive foil (e.g., a copper foil with an adhesive surface). Housing 305 and lid 301 can also be covered with an anti-static film, such as those used for ESD protection.

With a conductive housing as described above for module 120, chassis 101 can be made with corresponding conductive elements to make appropriate ground contact with module 120 upon insertion of module 120 into chassis 101. Referring to FIGS. 1 and 4, for example, each door 128 can be made from a conductive material or can include a conductive wiper (not shown) or spring element (not shown) on an outer face of the door. Upon insertion of module 120 into chassis 101, the module housing will contact the conductive face of door 128 to ground the module well before contact is made with connector 460. In addition or alternatively, rails 416 of rail plate 1101 (see FIG. 11) can be can be made from a conductive material or can include a conductive wiper (not shown) or spring element (not shown). Upon insertion of module 120 into chassis 101, the module housing will contact the conductive rail 416 to ground the module well before contact is made with connector 460.

In an another embodiment, the doors 128 can also be made of two pieces (optionally partly overlapping), one swinging upwards, and one swinging downwards (not shown in the figures) as the module 120 is inserted into the chassis 101. The doors 128 can also be made sufficiently flexible (e.g., the doors can be made from flexible spring elements) for bending while the module 120 is inserted (as opposed to rotating about an axis during insertion of the module 120).

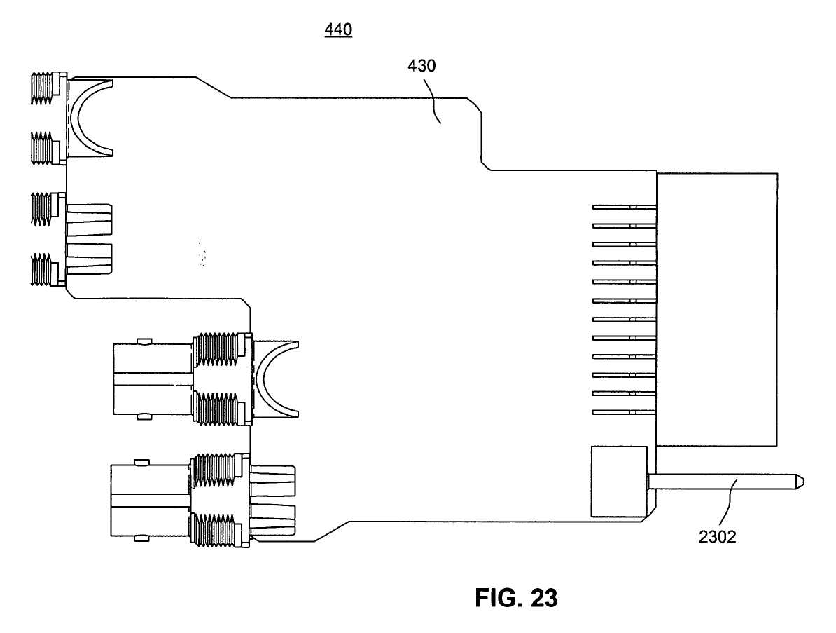

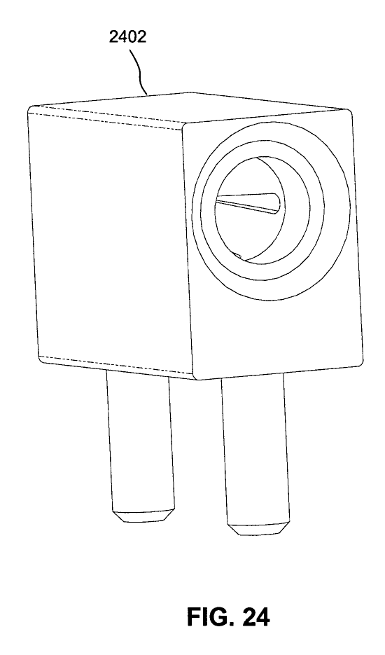

In yet another embodiment, a separate grounding connector may be added to module 120 to provide a large, low-impedance ground path. As illustrated, for example, in FIG. 23, a connector 2302 (e.g., a male pin is illustrated) can be added to fixed rear PCB assembly 440. A similar mating connector (e.g., a female socket, see 2402 in FIG. 24) can be added to module 120. Also, to permit the module to be inserted in both orientations, two such pin-and-socket grounding connectors can be used on both sides of the module 120. The pin of connector 2302 is made sufficiently long to establish a good ground path between module 120 and PCB assembly 440 before the signal pins of connector 460 make contact. A person skilled in the relevant art will recognize that pin/socket connector 2302 can be separate from or specially manufactured as part of connector 460.

It will be appreciated that the approaches to reducing the hot swap bit error rate described above can be combined in various ways. Problems involving, for example, electrical noise, signal interference, signal corruption and bit errors can be caused by a number of disparate environmental causes. As a result, such problem tend to be difficult to diagnose and solve. Using some of the techniques described above, alone and in various combinations, the inventors were able to reduce the occurrence of bit errors during hot-swapping in the DS3 tests discussed above. In specific telecommunication and other applications (involving different signal types, different data rates, and different environmental conditions), it is expected that some empirical testing will yield the best solution for bit error reduction or elimination on an application-by-application basis. In certain cases, it may be desirable to use the present invention in combination with various techniques to reduce static in the environment in which such cross-connect products are used. Such techniques are well known in the art and include, for example, anti-static flooring, humidity control and user adherence to procedural safeguards.

It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. A modular cross-connect comprising:
a chassis configured to receive a cross-connect module therein and including a front face and a rear cover;
a plurality of fixed printed circuit boards (PCBs) mounted in the chassis such that rear facing connectors of each of the fixed PCBs extend outward from the rear cover of the chassis, each fixed PCB further having a front-facing connector configured to mate with a rear-facing connector of the cross-connect module; and
a plurality of slots in the front face of the chassis, each slot configured to receive the cross-connect module and to align a rear-facing connector of the cross-connect module with the front-facing connector of the fixed PCB,
wherein each front-facing connector includes at least one ground contact and a plurality of signal contacts, such that upon insertion of the cross-connect module into the chassis, the at least one ground contact engages the rear-facing connector before the signal contacts engage the rear facing connector.

2. The modular cross-connect of claim 1, wherein the front-facing connector is an edge connector.

3. The modular cross-connect of claim 1, wherein the signal contacts are offset from the at least one ground contact.

4. The modular cross-connect of claim 1, wherein the signal contacts have curved portions that are offset from curved portions of the at least one ground contact by approximately 0.20 inches.

5. The modular cross-connect of claim 1, wherein each module includes a micro-strip line PCB with the rear facing connector that includes pads that engage the contacts of the front-facing connector.

6. The modular cross-connect of claim 1, wherein the front-facing connector is a multi-pin connector with a chamfered edge.

7. The modular cross-connect of claim 1, wherein the front-facing connector is a make-before-break connector.

8. The modular cross-connect of claim 1, wherein the module includes a conductive housing.

9. The modular cross-connect of claim 1, wherein the module include a conductive foil wrapped around the module.

10. The modular cross-connect of claim 1, wherein the module includes a housing with an anti-static film.

11. The modular cross-connect of claim 1, wherein the chassis is die cast.

12. The modular cross-connect of claim 1, wherein the chassis includes a rail plate for guiding the module during insertion, the rail plate comprising conductive rails.

13. The modular cross-connect of claim 1, wherein the chassis includes a plurality of conductive spring contacts for engaging the module prior to engagement of the signal contacts upon insertion.

14. The modular cross-connect of claim 1, wherein the front-facing connector comprises a first connector portion having signal contacts and a second connector portion having a mating half of a pin-and-socket connector, the second connector portion being configured to ground the module upon insertion of the module into the chassis prior to engagement of the signal contacts.

15. The modular cross-connect of claim 1, wherein the chassis includes a plurality of conductive doors, each door configured to guide the module during insertion.

16. A modular cross-connect comprising:
a chassis with a plurality of slots, each slot configured to receive a cross-connect module;
a cross-connect module insertable into the slots;
a plurality of fixed rear PCB assemblies mounted in the chassis and having a plurality of rear-facing connectors and a front-facing connector, each fixed rear PCB assembly providing cross-connections for at least two pairs of the rear facing connectors, wherein the rear-facing connectors extend outward from a rear portion of the chassis; and
the module having a rear-facing connector configured to mate with a front-facing connector upon insertion of the module into one of the plurality of slots of the chassis, wherein mating of a module with a corresponding fixed rear PCB assembly causes at least one of the cross-connections made by the fixed rear PCB assembly to be broken and re-made on the module such that the front-facing connector of the module may be used to break the at least one re-made cross-connection for re-routing of a signal therefrom,
wherein each front-facing connector includes at least one ground contact and a plurality of signal contacts, such that upon insertion of the cross-connect module into the chassis, the at least one ground contact engages the rear-facing connector before the signal contacts engage the rear facing connector.

17. The modular cross-connect of claim 16, wherein the front facing connector is an edge connector.

18. The modular cross-connect of claim 16, wherein the signal contacts are offset from the at least one ground contact.

19. The modular cross-connect of claim 16, wherein the signal contacts have curved portions that are offset from curved portions of the at least one ground contact by approximately 0.20 inches.

20. The modular cross-connect of claim 16, wherein each module includes a micro-strip line PCB with the rear facing connector that includes pads that engage the contacts of the front-facing connector.

21. The modular cross-connect of claim 16, wherein the front-facing connector is a multi-pin connector with a chamfered edge.

22. The modular cross-connect of claim 16, wherein the front-facing connector is a make-before-break connector.

23. The modular cross-connect of claim 16, wherein the module includes a conductive housing.

24. The modular cross-connect of claim 16, wherein the module includes a conductive foil wrapped around the module.

25. The modular cross-connect of claim 16, wherein the module includes a housing with an anti-static film.

26. The modular cross-connect of claim 16, wherein the chassis is die cast.

27. The modular cross-connect of claim 16, wherein the chassis includes a rail plate for guiding the module during insertion, the rail plate comprising conductive rails.

28. The modular cross-connect of claim 16, wherein the chassis includes a plurality of conductive spring contacts for engaging the module prior to engagement of the signal contacts upon insertion.

29. The modular cross-connect of claim 16, wherein the front-facing connector comprises a first connector portion having signal contacts and a second connector portion having a mating half of a pin-and-socket connector, the second connector portion being configured to ground the module upon insertion of the module into the chassis prior to engagement of the signal contacts.

30. The modular cross-connect of claim 16, wherein the chassis includes a plurality of conductive doors, each door configured to guide the module during insertion.
